(19) United States
(12) Patent Application Publication
(10) Pub. No.: US 2022/0107834 A1
(43) Pub. Date: Apr. 7, 2022

(54) TASK ENGINE

(71) Applicant: Osirium Limited, Berkshire (GB)

(72) Inventor: Andrew Steven Harris, Berkshire (GB)

(21) Appl. No.: 17/426,390

(22) PCT Filed: Jan. 28, 2020
(86) PCT No.: PCT/GB2020/050191

§ 371 Date: Jul. 28, 2021

(30) Foreign Application Priority Data
Jan. 28, 2019 (GB) 1901144.4

(51) Int. Cl. G06F 9/48; G06F 21/53; G06F 21/51

(52) U.S. Cl. CPC G06F 9/485; G06F 21/53; G06F 2221/2101; G06F 2221/2149; G06F 21/51

(57) ABSTRACT

Methods, systems, and apparatus of processing a task for execution at an end device by a task management system. The task management system is configured to provide a secure communication channel between a user device and an end device such that a user can request a task to be carried out at the end device via the task management system. The method comprises receiving an input configured by a first operating environment, the input relating to a task configured to be executed by an end device in a second operating environment determining the task from the input. The method further comprises converting the task into an output which is executable on the end device, and providing the output to the end device to execute the task.

### TECHNICAL FIELD

This invention relates to controlling execution of a task on a device by a task management system. In particular, but not exclusively, the invention may relate to controlling user access to tasks on a device by a task management system.

### BACKGROUND

A computer network within an organisation will typically contain a number of devices. The devices may include various computing devices and IT infrastructure such as PCs, servers, switches, routers, wireless access points, etc. The devices may be connected to the computer network at all times, or there may be periods of time during which a device is not connected to the network, either intentionally or unintentionally.

In order to keep devices in the computer network secure from unwanted interactions or control from within and/or outside the computer network, access to devices may be controlled and limited by securing access to the network and/or the devices in the network. Securing devices may involve providing credentials which authorise access to a device. In this instance, credentials may comprise any data that may be required to log in to an account for controlling access to the device, for example to provide a user ID and associated password data. Examples of password data may include a password itself, a hash of a password, a link or pointer to a password, etc.

Logging in to an account may provide full or partial access to one or more devices in a computer network. There are different types of actions that may be performed on a device. Some actions may be considered basic actions that pose a lower level of threat to the device. Such actions may for example comprise using a function of the device without changing any settings on the device, and without accessing any sensitive data stored on or relating to the device. Other actions may be considered to pose a higher risk to the security of the device. Such higher risk actions may for example include actions that affect the functionality of the device (e.g. changing control settings on a device), actions that may provide or require access to secure information of a device (e.g. performing, exporting, or restoring a backup operation), or actions that may introduce a security risk on a device (e.g. installing or updating software).

In order to differentiate between the level of access provided to different users, different accounts may provide different levels of access to a device. For example, some accounts may be regular user accounts, which provide access to basic functionality on a device. For example, a user logging in with a regular user account may be able to use standard functionality on a device, and perform basic actions on a device. Other accounts may provide access to higher risk actions on a device, for example an administrator account. Accounts with access to higher risk actions and functionality of the device may be referred to as privileged accounts.

Access to secure and privileged accounts may be limited by the entity managing the security of the device(s) and/or the computer network. However, the accounts may still pose a security threat, as some control over the security of the device(s) and/or network is lost by granting access to a privileged or other account. A user having legitimate access to a secure account may perform one or more actions or operations on a device that compromise its security. A privileged account may also be a priority target for an attack on the network or device. If access to a privileged account is gained by a malicious party, for example as a result of a data breach, the security of the device and/or network may be compromised.

It is noted that the actions for which secure access to a device and/or a network is required are often known and performed many times and by different users. The security of computing systems, networks and related devices can be significantly weakened where multiple users require access to common secure entities for the same or different actions. For example, access to a device or network may be provided by a common password which would be known to all users, or by the device being accessible via multiple user credentials and/or passwords.

The present invention seeks to provide systems and methods for controlling access to actions and operations to one or more devices on a computer network.

### SUMMARY

The present invention provides methods of processing a task for execution at an end device, a task management system, a network for controlling the execution of a task on an end device and a task engine backend server for providing data to the task management system.

According to a first aspect, there is described herein a method of processing a task for execution at an end device by a task management system, the task management system configured to provide a secure communication channel between a user device and an end device such that a user can request a task to be carried out at the end device via the task management system. The method may comprise receiving an input configured by a first operating environment, the input relating to a task configured to be executed by an end device in a second operating environment; determining the task from the input; converting the task into an output which is executable on the end device; and providing the output to the end device to execute the task.

Optionally, the method may further comprise receiving an initialisation request from a user; creating a secure container within the task management system in response to the initialisation request; sending a request for further information to the user; receiving the input within the secure container; and converting the task into an output which is executable on the end device within the secure container. Optionally, the method may further comprise creating a task log to store actions and events of the task management system in a task log. Optionally, the task log may be stored in a digital distributed ledger. Optionally, the task log may be created contemporaneously to the secure container. Optionally, receiving the input comprises receiving the task from a predetermined plurality of tasks provided on a user device. Optionally, converting the task to an output executable on the end device may comprise retrieving a copy of the determined task, and combining the task with the input to determine an output. Optionally, the method may further comprise storing, by the task management system, task execution data in relation to the task. Optionally, the method may further comprise receiving a confirmation that the task has been executed, and removing the task execution data after receiving the confirmation that the task has been executed. Optionally, the method may further comprise destroying the secure container after execution of the task. Optionally, the method may further comprise receiving a communication configured in the second operating environment, and determining a further output based on the communication configured in the second operating environment. Optionally, the method may further comprise providing the further output as an input to the task management system. Optionally, the method may further comprise, in response to the communication performing a further task, providing an output of the further task as further output. Optionally, the method may further comprise requesting further input from a user device or an end device. Optionally, the method may further comprise temporarily pausing the execution of the task. Optionally, the task management system may perform static analysis on the input before execution of the task. Optionally, the task management system may determine a runtime key for a virtual vault, wherein the runtime key is provided to one or both of the task and the secure container. Optionally, the runtime key is provided in response to the initialisation request. Optionally, the virtual vault may be populated with security credentials relating to the task. Optionally, the method may further comprise accessing the virtual vault to obtain the security credentials. Optionally, the method may further comprise attaching the security credentials to the output prior to providing the output to the end device. Optionally, the input may comprise user credentials, wherein the user credentials are different to the security credentials relating to the end device. Optionally, the task processed by the task management system may comprise multiple steps, wherein each step comprises an interaction with at least one of the end device or the task management system. Optionally, the task may be performed on a plurality of end devices.

According to another aspect there is described herein a method of processing a task for execution at an end device by a task management system, the task management system configured to partition a communication channel between a user device and an end device such that a user can request a task to be carried out at the end device via the task management system. The method may comprise receiving an initialisation request from a user; creating a secure container within a task management system in response to the initialisation request; sending a request for further information to the user; receiving within the secure container an input relating to a task configured to be executed by an end device; determining the task from the input; converting the task into an output which is executable on the end device; and providing the output to the end device to perform the task.

According to another aspect there is described herein a task management system for performing a task on an end device. The task management system may be configured to provide a secure communication channel between a user device and an end device such that the user can request a task to be carried out at the end device via the task management system. The task management system may comprise a receiver configured to receive, from a user interface, an input configured by a first operating environment, the input relating to a task configured to be executed by a end device in a second operating environment; an execution module configured to determine the task from the input; convert the task into an output; and a transmitter configure to provide the output to the end device, wherein the end device is configured to perform the task while the user is separated from direct access to the end device.

According to another aspect there is described herein a network for controlling the execution of a task on an end device. The network may comprise a user device comprising a user interface configured to control interaction between a user and the system, wherein the user device is configured to transmit an input instructing a task management system to perform a task; a task management system configured to receive the input from the user device and transmit an output to a user device, and a device configured to receive an output from the task management system, and execute a task based on the received output.

According to another aspect there is described herein a task engine backend server for providing data to the task management system according to the method described above. The task engine backend server may comprise executable code for creating a secure container environment within the task management system; an operating environment repository configured to provide operating environments to the task management system; a task repository configured to provide tasks to the task management system; a location of an end device; and a key to a virtual vault.

Optionally, the backend may be configured to provide one or more of the executable code, operating environment repository; task repository; location of an end device and location of a virtual vault upon receipt of an initialisation request according to the method described above.

It will be understood that the features defined in accordance with any aspect of the invention or disclosure, above or below, relating to any specific example, embodiment or aspect may be utilised, either alone or in combination with any other defined feature, example or aspect to form a further aspect or embodiment of the invention.

### BRIEF DESCRIPTION OF THE DRAWINGS

Exemplary embodiments of the invention will now be described with reference to the accompanying drawings, in which:

FIG. 1 depicts an architecture of a task management system connected to a plurality of user devices and a plurality of end devices;

FIG. 2 depicts a schematic diagram of a task management system;

FIG. 3 depicts a flow diagram of an exemplary method of processing a task by a task management system for execution on a device;

FIG. 4 depicts a flow diagram of an exemplary method of processing a task by a task management system comprising the creation of a secure container;

FIG. 5 depicts a flow diagram of an exemplary method of providing further processing of a task during execution; and

FIG. 6 depicts a signalling flow diagram of an exemplary method of processing a task by a task management system for execution on a device; and

FIG. 7 depicts a signalling flow diagram of an exemplary method of requesting and retrieving security credentials for a task in a secure container.

### DETAILED DESCRIPTION

Generally disclosed herein are systems and methods for controlling access to actions and operations to one or more devices on a computer network, in order to improve security of the computer network. The system may be a task management system, and may specifically be a secure and/or privileged task management system.

Operating a network generally requires performing actions and operations that require access to secure settings and data within the network (e.g. installing and updating software, performing backup operations). In order to make the network more secure, access to certain actions and operations in the network, and on devices within the network, may be restricted and only provided to certain accounts.

The systems and methods described herein may provide a more secure operation of the network by separating the credentials from users and authors/developers of tasks and operations on the network. Advantages of the systems and methods described herein may include that the system provides a way to protect credentials from the user, and inhibits direct device access by the user. The system may also prevent authors/developers of tasks accessing the credentials. The system may further protect credentials from being logged, for example in a task log or external log. Furthermore, the separation of credentials from tasks and operations by the system may prevent tasks from being run by unauthorised users and/or systems, as no credentials are present in the tasks.

In the following description, the accounts are typically described as being secure and/or privileged accounts. However, this should not be seen to be limiting and the accounts may or may not be privileged and the systems and methods described herein may be applicable to any password protected account which may require a secure password and/or user credentials to access it.

An account may be protected by credentials that may be provided to the network and/or device(s) to gain access to the restricted actions and operations. The credentials to each account may be known to one or more users. It may be difficult to maintain a clear overview of which users have access to an account, and who is accessing an account, as users may share credentials with each other, and/or third parties may obtain credentials unintentionally.

Providing secure access, for example via a privileged account, may provide a user with more access than required for them to perform the actions they are intended to perform on one or more devices in a network. One way in which networks address this issue is to have different privileges and permissions associated with different accounts. For example, some accounts may have a limited amount of permissions, while other accounts, whose credentials may be more strictly controlled, may have a larger amount of permissions. Such an approach may limit exposure of secure settings and data within a network, by further limiting the amount of users that have access to certain privileges, and creating several levels of access. However, the accounts with larger amount of privileges are still vulnerable to the same types of misuse and intentional and unintentional credential sharing.

Users of secure and/or privileged accounts often require privileged access to perform one or more known tasks, for example to update or install a piece of software on one or more devices in the network, to perform a backup operation, to test a specific function of a device, etc. A task may be a collection of one or more actions to be performed on one or more devices on the network. A secure account may be accessible to a single user, or to a plurality of users, for example a team of users. Different accounts may be accessed by different one or more users. Some users may have access to a plurality of accounts. An account may provide access to a plurality of tasks. Different accounts may provide access to the same or to different tasks, that is to say, there may be no overlap, partial overlap, or full overlap between tasks accessible by different accounts. A task may be accessible by one or more accounts.

The user (or task operator as they may also be referred to) may not be the same person during any individual run of a task. For example, a task may be started by a first user and different inflight queries may be handled by users. Further, users may have the rights to view the task or an overview thereof. For example, one or more different users may be able to track the status or progress of a task which they may or may not have access to or control of.

Described herein are systems and methods of further securing devices on a computer network by controlling actions and operations that may be performed on a device by a secure and/or privileged account. This may be achieved by limiting access to a network and its devices from a secure and/or privileged account to performing one or more tasks linked to that account. Further described herein is a task management system that manages task execution within a network, specifically, it manages execution of tasks on one or more devices in a network. The task management system may further provide flexibility in relation to the execution of one or more tasks, for example, including pausing the execution of a task, asking for further user input during execution of a task, calling a task within a task, etc. Tasks may be coded for expected situations. When an unexpected issue or situation arises, the task management system may have the ability to notify one or more users. At least one of the users may then respond to the notification to interact and resolve unexpected situations.

It may be advantageous to provide a system that manages task execution on devices so that it may enable privileges linked to secure accounts to be limited to specific sets of actions and operations herein referred to as tasks. Specifically, the task management system may provide for each secure account a selection of tasks, wherein the task management system has control over which tasks may be provided to which secure account. This has the advantage of being able to control which actions may be performed by a user of a secure account. The task management system may provide a further advantage in that it may enable control over the content of the tasks provided to the secure accounts for execution. It may limit access for each secure account to a selection of tasks it that have may be determined, tested, and approved for execution, for example by an entity managing the security of the network, or verified trusted parties. The task management system may further perform security analysis on the tasks to be performed, for example static analysis on the code of a task. Static analysis may, for example, be performed to check that secure information, e.g. credentials, within the task are not abused, that is to say, used in a way unauthorised by the task management system. Static analysis may also for example check for and/or prevent attempts made to copy or have secure information leave the task. The static analysis may be referred to as static programme analysis, or static code analysis. The static analysis may result in a warning being provided to the client by way of a visual or audible cue, and/or a pausing or ceasing of a task or action.

Actions performed by a user, for example in the form of tasks provided by the task management system selected by a user, may be logged by the task management system, to monitor activities by a user on a privileged account. If a user tries to perform an action other than the provided tasks, the task management system may prohibit this by not enabling the user to forward such instructions onto the network functioning as a barrier. The task management system may log any attempted prohibited tasks which may be used to detect suspicious and/or malicious behaviour on a privileged account. The method may include the steps of processing a task for execution at an end device by a task management system.

The task management system may be configured to provide a secure communication channel between a user device and an end device such that a user can request a task to be carried out at the end device via the task management system. The user request may be received by the device only from the task manager The user request may be sent from the user device only to the task manager. The method may comprise: receiving an input configured by a first operating environment, the input relating to a task configured to be executed by an end device in a second operating environment; determining the task from the input; converting the task into an output which is executable on the end device; and providing the output to the end device to perform the task.

An advantage of the task management systems and methods described herein is that they may provide a barrier between a user of a privileged account needing to perform one or more privileged actions, and network and/or devices on which these actions need to be performed. The task management system provides an interface separating users from the network by making the instructions and actions by a user go through the task management system, and blocking a user from directly accessing secure accounts on the network and/or devices on the network.

The method may include receiving an initialisation request from a user; creating a secure container within the task management system in response to the initialisation request; sending a request for further information to the user; receiving the input within the secure container; converting the task into an output which is executable on the end device within the secure container.

Creating a secure container upon an initialisation request allows a secure environment to be established using predefined parameters. For example, the secure environment may be populated with predetermined tasks which are permitted for the requesting user, device credentials or an address to a virtual vault can be stored within the secure container to further separate the user from the device credentials. The secure container can also include knowledge of the device which is needed to for execution of the task but which is not deemed suitable for sharing with the requesting user. Such information may include the operating environment, location or other properties of the device.

Providing a secure container also provides an advantageous way of containing all of the task related actions such that they can be removed from the system, together with the security sensitive information, once the task is complete.

The systems and methods described herein may be employed in numerous applications in which control of access is required between users and end devices. In one example, the system and methods may be employed in a construction environment in which a computer network and/or IT infrastructure is assembled. In order to construct the computer network or IT infrastructure, it may be necessary for different users to access different parts for specific tasks. The privileges associated with the different tasks may be determined by the role of the user in question, or the entity they are employed by and multiple users may require access to the same piece of equipment for different reasons and in different ways with differing permissions.

For example, IT infrastructure may be required for a communications or security hub which may be used to control security or communications for an event or location. Such a hub may include a plurality of servers, PCs, sensors, actuators, input and output devices, communication channels, user interfaces, security equipment (e.g. cameras, access keypads) etc. Access to the different types of equipment may be restricted to particular users from the same or different organisations and access control must be monitored closely and, in some circumstances, the actions of each user carefully recorded. Providing proper control and monitoring may increase the efficiency and security of the construction and allow different organisations to work more closely together. The systems and methods described herein may provide a suitable platform which can provide the necessary flexibility and accountability in a secure manner for creating temporary, or permanent, arrangements.

In another example, it may be necessary to provide different users with operational access to different parts or aspects of a product or entity. For example, a train or vessel may include several components which can be controlled directly by a primary system, and remotely via a secondary system, perhaps in the event of the primary system failing Systems and methods described herein may be used to control who can access and operate the different components, from where and under what circumstances. For example, a remote user may be required to operate the doors of the train where an internal system fails. In such a circumstance, the remote operation needs to be performed only by an authorised user under predetermined conditions when the train is stationary and in the correct location. Further, it would be desirable that such an operation is carried out in an accountable and traceable manner. The task manager described herein may be configured to allow such a controlled and traceable interaction.

The systems and methods described herein may also be implemented to allow a user to interact with a device in which the operating software (e.g. operational environment) is unknown or restricted to the user. Thus, a user may employ a user device having a first operating system which is not directly compatible with the operating environment of the device. Providing suitable secure task manager may circumvent this and allow the user to interact without detailed knowledge. Hence, the operator or owner of the end device may further restrict knowledge of the end device from the user.

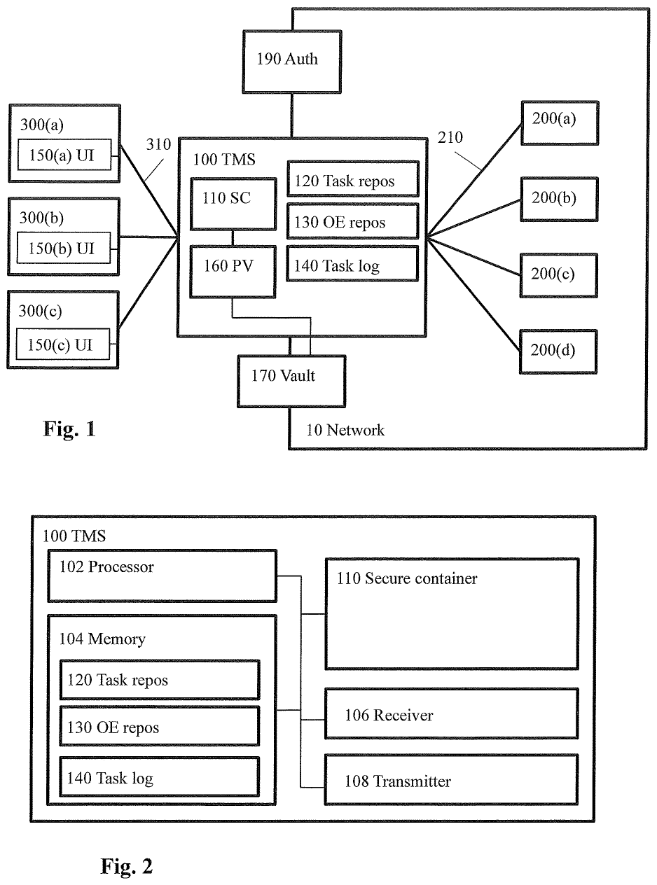

FIG. 1 depicts a computing system in which a task management system (TMS) 100 is configured to control execution of one or more tasks on a plurality of end devices 200(a)-(d) in a network 10. The task management system 100 may provide the connection between a plurality of end devices 200(a)-(d) via one or more connections 210 and a plurality of user devices 300(a)-(c) via one or more connections 310. The task manager system 100 may therefore partition the end devices and user devices to prevent direct contact and communication between the two. In doing so, the task management system 100 may retain control of several central aspects of the computing system and improve security. An authentication service 190 which is responsible for authenticating the credentials required to access each of the devices is also shown. The authentication service 190 may be provided remote from the TMS 100, or as an integral part thereof.

The end devices 200(a)-(d) may be similar or different to each other, with each requiring the same or different access credentials The end devices 200(a)-(d) may be any which a user may require operational access to for a particular purpose and may include components such as PCs, servers, switches, routers, wireless access points, actuators, sensors or any other component or system, as may be appropriate. The end devices 200(a)-(d) will typically be located remotely with respect to the users and user devices 300(a)-(c). However, this need not be the case and the users may be physically co-located with the end devices 200(a)-(d).

The end devices 200(a)-(c), user devices 300(a)-(c) and TMS 100 may each include one or more processors, memories, input devices, and output devices.

The input devices and output devices may be coupled to one another in each respective unit via a wireless link and may consequently comprise transceiver circuitry and one or more antennas. Additionally or alternatively, the input devices and the output devices may be coupled to one another via a wired link and may consequently comprise interface circuitry (such as a Universal Serial Bus (USB) socket). It should be appreciated that the input devices and output devices may be coupled to one another via any combination of wired and wireless links. Similarly, the end devices 200(a)-(d), user devices 300(a)-(c) and TMS 100 may be connected to one another using any combination of wired or wireless links. The wireless may, for example, be a WLAN (IEEE 802.11), Ethernet (IEEE 802.3), LTE, 4G or 5G connection.

The end devices 200(a)-(c), user devices 300(a)-(c) and TMS 100 may comprise any suitable circuitry to cause performance of the methods described herein. The end devices 200(a)-(c), user devices 300(a)-(c) and TMS 100 may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU); and/or a graphics processing unit (GPU), to perform the methods.

In various examples, the end devices 200(a)-(c), user devices 300(a)-(c) and TMS 100 may comprise at least one processor and at least one memory. The memory stores a computer program comprising computer readable instructions that, when read by the processor, causes performance of the methods described herein. The computer program may be software or firmware, or may be a combination of software and firmware.

The processors and memories may be located in the devices 200(a)-(d), 300(a)-(c) or TMS 100, or may be distributed between different machines. For example, the TMS 100 may be embodied in one or more computers or servers within the network and the user devices 300(a)-(c) may be distributed in a user network, part of which is remotely accessed. The processors may each include at least one microprocessor and may comprise a single core processor, may comprise multiple processor cores (such as a dual core processor or a quad core processor), or may comprise a plurality of processors (at least one of which may comprise multiple processor cores).

The memory may be located in each of the end devices 200(a)-(c), user devices 300(a)-(c) and TMS 100, or may be located remotely from each, or possibly distributed between different locations. The memory may be any suitable non-transitory computer readable storage medium, data storage device or devices, and may comprise a hard disk and/or solid state memory (such as flash memory). The memory may be permanent non-removable memory, or may be removable memory (such as a universal serial bus (USB) flash drive or a secure digital card). The memory may include: local memory employed during actual execution of the computer program; bulk storage; and cache memories which provide temporary storage of at least some computer readable or computer usable program code to reduce the number of times code may be retrieved from bulk storage during execution of the code.

The computer program(s) may be stored on a non-transitory computer readable storage medium. The computer program(s) may be transferred from the non-transitory computer readable storage medium to the memory. The non-transitory computer readable storage medium may be, for example, a USB flash drive, a secure digital (SD) card, an optical disc (such as a compact disc (CD), a digital versatile disc (DVD) or a Blu-ray disc). In some examples, the computer program may be transferred to the memory via a wireless signal or via a wired signal.

Each user device 300(a)-(c) and TMS 100 may include an input device and one or more output devices. The user input device may comprise any suitable device for enabling an operator to at least partially control the end devices 200(a)-(c), user devices 300(a)-(c) and TMS 100. For example, the user input device may comprise one or more of a keyboard, a keypad, a touchpad, a touchscreen display, and a computer mouse.

The output devices may be any suitable device for conveying information to a user. For example, the output device may be a display (such as a liquid crystal display, or a light emitting diode display, or an active matrix organic light emitting diode display, or a thin film transistor display, or a cathode ray tube display), and/or a loudspeaker, and/or a printer (such as an inkjet printer or a laser printer). The controller is arranged to provide a signal to the output device to cause the output device to convey information to the user.

The output device may include a user interface 150(a)-(c) operable by users of the user devices such that they can receive information from and select and send information to the task management system 100 and computer network 10. Connections 310 may be wired and/or wireless.

The task management system 100 may comprise a secure container (SC) 110. The secure container may be created upon request and used for containing, processing, and executing the necessary steps associated with requested tasks. The secure container may include or be populated with a task repository 120 for storing one or more approved tasks that may be provided by the task management system 100 in association with one or more secure accounts. The secure container may include or be populated with an access key to a virtual vault 170 or a proxy vault 160. The virtual vault 170 may store security credentials such that the security credentials can be called when a task is being prepared for sending to an end device 200(a)-(c). The virtual vault 170 may be separate from the task management system 100. The virtual vault may also be referred to as a vault. A secure communication channel may exist between a virtual vault 170 and a proxy vault 160 of the task management system 160.

The task management system 100 may further comprise an operating environment (OE) repository 130 which includes or is populated with one or more operating environments or executable code associated with an operating environment required for executing a task on the end device. Providing an operating environment repository as part of the task management system allows a request to be received from a first operating environment in accordance with the user device 300(a)-(c) and outputted in a second operating environment which is utilised by the end device. In this way, knowledge of the device is not required by the user which provides a greater degree of flexibility and security. An operating environment may be an operating system (OS).

Task management system 100 may further comprise a task log 140 for logging events and actions performed by users, devices, and/or the task management system 100. The use of a task log 140 is advantageous as it allows the tasks and steps taken in association with the task to be recorded for future reference. This means that the elements of the task manager required for execution of the method, such as the secure container and/or the credentials and/or the link to a virtual vault 170 for example, may be removed once a task is complete whilst retaining the actions taken. An advantage of using a task log 140 in which credentials and/or the link to the virtual vault are removed may be that the credentials are protected from logging systems.

The task management system 100 may further comprise a proxy vault (PV) 160. The proxy vault 160 may be accessible to the secure container 110, or a task within the secure container 110. The proxy vault 160 may deny access to any parties other than the secure container 110 or a task started within the secure container 110. The proxy vault 160 may effectively form a private connection to the secure container 110 or a task started within the secure container 110. The proxy vault 160 may be connected to a virtual vault 170. A virtual vault 170 may be located inside network 10, as illustrated in FIG. 1, or may be located outside network 10. The proxy vault 160 may be in secure communication with the virtual vault 170. The virtual vault 170 may be used to store secure information for the task management system 100, for example security credentials.

FIG. 2 depicts a schematic representation of a task management system 100. The task management system 100 comprises a processor 102 and memory 104. The task management system 100 may for example be a server, or other computing device. The memory may contain one or more of task repository 120, operating environment repository 130, and task log 140. Alternatively, one or more of task repository 120, operating environment repository 130, and task log 140 may be contained within a memory connected to but external to the task management system 100.

Task management system 100 further contains a receiver 106 and transmitter 108 for receiving and transmitting data to user devices 300(a)-(c) and end devices 200(a)-(d) in network 10. The task management may have separate receivers and/or transmitters for data transfers to and from user devices 300(a)-(c), and to and from end devices 200(a)-(d).

Task management system 100 may further contain the secure container 110, in which a task can be received and converted to an output. The secure container 110 may make use of processor 102 and/or memory 104, or separate processing and/or memory resources may be available on task management system 100 for use by secure container 110. A task management system may comprise a plurality of secure containers 110, and may have the ability to create and/or delete secure containers 110 prior to and after the commencement and completion of a task. The secure container 110 may be a sandbox as is known in the art.

The system may further include a separate computing device, such as a server, which stores the instructions for creating the secure container and the contents of thereof. Thus, when an initialisation request is received by the task manager, a request can be sent to the secure container computing device and the information required for creating the secure container. This initialisation request may include information relating to the user requesting the task, details of the task, and the device to which the task is directed. Using this information, the secure container server may create or identify one or more of the key to a virtual vault 170 in which the end device credentials may be stored by the task manager or end device, the task log, list of tasks the end user is permitted to use, the operating environment repository etc.

A user device 300(a)-(d) may provide credentials to gain access to a secure account. The secure account may be a privileged account. This may involve a user providing credentials to the task management system 100 itself, or alternatively, the task management system 100 may be connected to an authentication service that will confirm credentials from a user and device whether or not to grant the user access to a secure or privileged account. In one example the user may provide user credentials to an authentication service (Auth) 190 at the edge of the secure network, wherein devices at the edge of the network are devices that are able to communicate securely within the network, as well as communicate with entities outside the network.

User credentials and authentications may include for example passwords, biometrics, multifactor authentication, and other known methods for determining the identity of a user. Authentication of user credentials may serve to confirm the identity of the user to the task management system 100. The identity of the user may be used by the task management system 100 to grant or deny permission to requests, for example requests for access to tasks and/or security credentials in a virtual vault 170.

Communications inside and outside the network may be separated by the device, in order to keep the network 10 secure. If the authentication service 190 accepts the user credentials, it may carry out the steps necessary to initiate a secure environment within the task management system in accordance with the permissions attributed to the authenticated user credentials. As described below, the secure environment, e.g. a secure container/sandbox, may have access to or retrieve privileged account passwords and/or keys for accessing a device which is authorised for use by the user credentials. Thus user credentials may be used for providing access to a secure account without the user having direct access to the password or key.

The secure account password may be more secure than the user password known to the user (e.g. longer password, determined and updated by authentication service 190 itself), and may be kept inside network 10 so that they may avoid being compromised or intercepted in the unsecured environment outside network 10. Connections 210 and 310 may be secure connections creating a secure communication channel between a user device 300(a)-(c), task management system 100, and/or end device 200(a)-(d).

Once a user has gained access to the secure account by providing the necessary credentials, the task management system 100 may associate one or more tasks to the account. The list of tasks may be created with the creation of the secure container. The task management system 100 may provide the selection of one or more tasks associated with the account to the user, via user interface 150(a)-(c), which may be a graphical user interface. The user interface may be provided on a user device 300(a)-(c) used by the user. The user interface may) may be provided to a device at a location outside network 10.

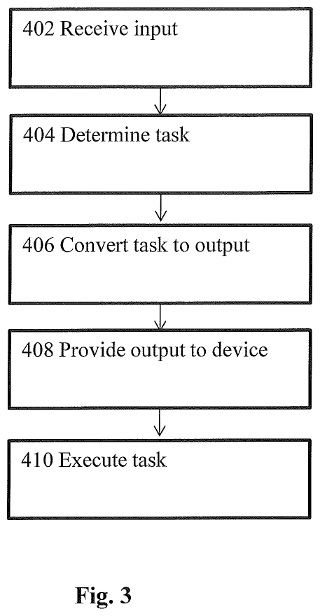

FIG. 3 depicts steps in a method of processing a task for execution on an end device by a task management system 100. The task management system 100 may be configured to provide a secure communication channel between a user device 300(a)-(c) and an end device 200(a)-(d) so that a user can request a task to be carried out at the end device 200(a)-(d) via the task management system 100 and only via the task management system 100.

In step 402 the task management system 100 may receive, via receiver 106, an input from a user via a user interface 150(a)-(c) on user device 300(a)-(c). The input may be configured by a first operating environment, and may relate to a task to be executed by an end device 200(a)-(d) in a second operating environment. In step 404 the task management system 100 may determine a task from the received input. In step 406 the task management system 100 may convert the task into an output which is executable on the end device 200(a)-(d). In step 408 the task management system 100 may provide the output to end device 200(a)-(d), so that in step 410 the task may be executed by end device 200(a)-(d) based on the received output.

In the method described above, the first operating environment may be the operating environment of the user interface 150 and/or task management system 100. The second operating environment may be the operating environment of the end device 200(a)-(d). The first and second operating environments may be the same or different.

Step 404, determining the task, may comprise determining one or more tasks to retrieve from the task repository 120, based on the received input. Determining the task may further comprise determining one or more operating environments to retrieve from the OE repository 130. Determining the task may further comprise placing the retrieved one or more tasks and/or operating environment into secure container 110. Determining the task may further comprise determining one or more task input parameters from the received input, and placing the task input parameters into secure container 110.

Step 406 of converting the task may comprise processing data placed in the secure container 110 in order to determine a suitable output. Data placed in secure container 110 may comprise one or more tasks, operating environments, and/or task input parameters.

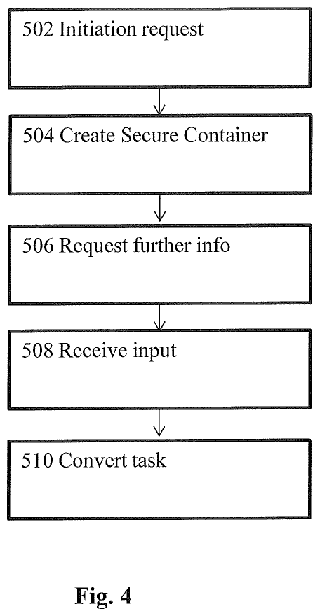

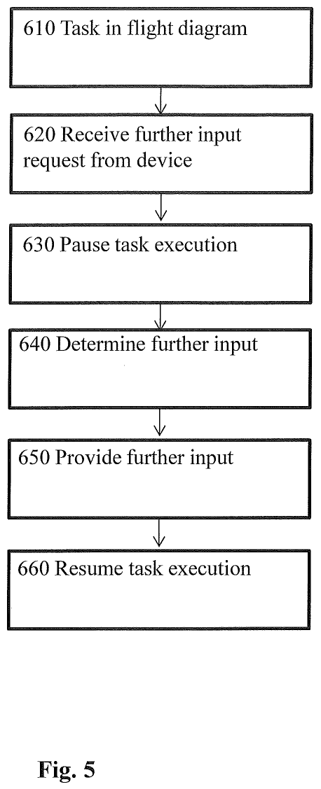

FIG. 4 shows an example implementation of creation and use of a secure container. Before receiving an input from a user device 300(a)-(c), the user device 300(a)-(c) may send an initialisation request 502 to the task management system 100. Upon receiving an initialisation request, the task management system 100 may create 504 a secure container 110 within the task management system 100 in response to receiving the initialisation request. Once the secure container has been created, the task management system 100 may send a request for further information 506 to user device 300(a)-(c). This may notify the user device 300(a)-(c) that the initialisation of the secure container 110 has been completed, and be seen as an indication to user device 300(a)-(c) that input 508 may now be sent to the task management system 100 to convert 510 into a task to be executed by an end device 200(a)-(d). The request for further information sent to the user device may include a list of tasks from which the user can select, information relating to the device, information relating to the operating environment of the user device 300(a)-(c), further verification of the user credentials, etc.

A task management system 100 may be able to handle multiple tasks simultaneously, either from the same or different user devices 300(a)-(c) and/or privileged accounts. A potential advantage of creating a secure container in relation to an account on a user device 300(a)-(c) is that different tasks from different user devices 300(a)-(c) and/or privileged accounts may be separated on the task management system 100. This separation makes the system more secure, as separate tasks do not interact and can be separately controlled.

In one example, upon receipt of privileged account details, the task management system 100 may determine a plurality of tasks that may be executed by that privileged account. The task management system may transmit the selection of the determined tasks to the user device 300(a)-(c). The user device 300(a)-(c) may display the plurality of predetermined tasks on user interface 150(a)-(c), so that a user may select one or more tasks for execution on an end device 200(a)-(d).

Input received by the task management system 100 from a user device 300(a)-(c) may comprise receiving data identifying a task from a predetermined plurality of tasks provided on the user device 300(a)-(c). The predetermined plurality of tasks may be provided to a user device 300(a)-(c) by the task management system 100. The task management system 100 may receive the task input as a result of a user selecting a task provided at the user device 300(a)-(c). Receiving a task may comprise receiving data comprising information identifying the task to the task management system 100. The plurality of tasks may comprise a list of predetermined tasks that may be performed on one or more end devices 200(a)-(d) in network 10. The list of available tasks provided by the task management system 100 may be dynamic, that is to say, it may change over time depending on one or more properties of for example the task management system 100, the device, or previous actions performed by a user and/or on one or more end devices 200(a)-(d). In one example, a task may only be performed under specific conditions. For example, predetermined tasks may include an ‘initialise device session’ task, and an ‘end device session’ task. Until a device session has been initialised, the end device session task may not be provided as available by the task management system to a user. Similarly, the initialise device session task may not be available to a user while a device session is ongoing.

Input received by the task management system may further comprise data identifying one or more end devices 200(a)-(d) on which a task is to be performed. The data may be based on a user selecting one or more end devices 200(a)-(d) at the user device 300(a)-(c). Selecting a device may be performed before or after selecting a task. Selecting one or more end devices 200(a)-(d) may comprise selecting the one or more end devices 200(a)-(d) from a list of devices provided by the task management system 100. Different end devices 200(a)-(d) may have a different predetermined plurality of associated tasks. When selecting a device 200(a)-(d) before selecting a task, the list of tasks provided by the task management system may be adjusted based on the selection of device. If a task is selected before a device is selected, a list of devices on which the task may be performed may be provided by the task management system, wherein the content of the list may depend on the selected task.

The list of available tasks and/or end devices 200(a)-(d) may depend on the account requesting execution of one or more tasks Different accounts may provide access to different tasks and/or end devices 200(a)-(d).

Selection of a task from a list of available tasks may be performed by a user accessing a privileged account. In order to interact with a user, the task management system 100 may comprise a user interface 150(a)-(c). The user interface 150(a)-(c) may comprise a receiver and a transmitter in order to interact with the task management system 100 and user. In one example, once a user has successfully logged in to a privileged account, the user interface 150(a)-(c) may present the user with a list of task available to that account. A user may transmit a selection of a task to be performed to the user interface 150(a)-(c). The user interface 150(a)-(c) may indicate the status of a selected task to a user, for example, a user interface may indicate that a task is in progress, that a task is successfully completed, it may request further input, or it may display an error message.

After a task management system 100 has received an input relating to a task, it determines the task from the input. This determining step may comprise analysing the input to identify data in the input identifying the task. The data identifying the task may comprise, for example, a task identification. In some instances, the task management system 100 may combine several items of data comprised within the received input in order to determine the task. For example, the input may comprise data identifying a task category, and further data identifying an end device 200(a)-(d). The task management system 100 may combine the task category data and end device data to determine the task in the task category to match the identified end device.

After determining the task, the task management system 100 may convert the task and generate an output executable at an end device 200(a)-(d). The end device 200(a)-(d) may operate in a second operating environment, and the generated output may be configured to be interpretable an executable in the second operating environment. Converting the task may comprise the task management system 100 retrieving a copy of the determined task, and combining the task with the input to determine an output. The task may be retrieved from a task repository 120. The task management system 100 may also determine the second operating environment and retrieve data relating to the second operating environment from OE repository 130. The retrieved task may be placed in secure container 110, where it may be combined with the retrieved data relating to the second operating environment so that the output may be generated to be compatible with the second operating environment of the end device 200(a)-(d). Input data to be combined with the task may also be placed in the secure container 110. Input data to be combined with the task may for example comprise data relating to input variables to be provided to the task. The task may be combined with the input data and operating environment data in the secure container 110. Determining an output may comprise generating a set of instructions based on the task, the input, and the operating environment data, that may be interpreted and executed by an end device 200(a)-(d) in order to perform the task.

Once the output has been determined, the task management system 100 may provide the output to an end device 200(a)-(d) for executing the task. The output may be configured to be interpretable and executable in the second operating environment of the end device 200(a)-(d). The output may be provided as a single data transfer, comprising one or more instructions that may be interpreted by the end device 200(a)-(d) to execute the task. Alternatively, the task management system 100 may transmit a series of portions of the output to the end device 200(a)-(d) consecutively. In some instances, the task management system may await a response from the end device 200(a)-(d) before sending the next portion of the output to the end device 200(a)-(d).

The task management system 100 may receive, during execution of a task by an end device 200(a)-(d), a communication from the end device 200(a)-(d). The communication may relate to a request for further information or for an action to be completed by another entity or device so that the task can be completed.

Based on the received communication, the task management system 100 may determine a further output. The communication may relate to a task that is currently being executed by the end device 200(a)-(d), which may be referred to as a task in flight. The communication may comprise a request for further input to the end device 200(a)-(d) in order to execute the task. For example, where the task relates to the opening of a valve in a process line, it may be necessary for certain checks to be carried out before the valve can be opened. These additional requirements may not be known to the task manager or user in the first instance but lie in the domain of the end user.

After sending the communication to the task management system 100, the end device 200(a)-(d) and/or the TMS 100 may pause execution of the task in flight until a response is received by the end device 200(a)-(d). This response may be the further output determined by the task management system 100. Alternatively or additionally, the task management system may perform further steps in order to determine and provide a response to the end device 200(a)-(d).

The further output determined by the task management system 100 may be used by the task management system 100 as an input, for example, for performing a further task. In response to the further input, the task management system may perform a further task, for example, on the same end device 200(a)-(d) that sent instructions, or another one of the end devices 200(a)-(d). The further task executed may provide an output, which may be provided to the task management system 100. The output of the further task may be provided as further output by the task management system 100, as part or as a whole of a response to the end device 200(a)-(d). The task management system 100 may also perform a plurality of tasks in response to receiving a communication requesting further input, wherein the further tasks may be performed in parallel, in series, or a combination of both.

As a result of the further task being executed, the task management system 100 may receive further data, which it may use for providing a response to the communication of the end device 200(a)-(d). Once the end device 200(a)-(d) has received a response to the communication it may continue execution of the task and use the received response in the execution.

Using the task management system 100 in this way allows the multiple end devices to be contacted and tasks carried out without the interaction of the user. This can be particularly advantageous where different end devices 200(a)-(d) are configured to trust instructions or tasks originating from other end devices 200(a)-(d) without the need to request further credentials.

The task management system 100 may request further input from some or all of the end devices 200(a)-(d), the user device 300(a)-(c) from which the input was received, and/or another user device 300(a)-(c). The further input may be requested as part of determining the task, converting a task to an output, determining a further output in response to a request from an end device 200(a)-(d), to provide information to a user device 300(a)-(c), or as part of any other action performed by the task management system 100.

An advantage of pausing a task in flight and requesting further input is that multiple users may contribute to a task. It is possible for the task to request further input from the privileged account that initiated execution of the task, via user device 300(a)-(c) from which the input was received. If the user of that privileged account is not able to provide the further input themselves, they may request input from another party, for example another privileged account. This other party may provide the further input to the user, or to the task management system 100 directly. It is also possible for further input to be requested to another party by the task management system 100 itself. A task may be configured to have different users handle different portions of execution of the task. For example a task may be configured to have a first user handle a first portion of the task execution, a second user handle a second portion of the task execution, and a third user handle a third portion of the task execution. These users may be from different organisations in which permissions differ and the sharing of secure data is restricted.

To have a different user handle the task management system 100 may transmit a request for further input to a second account, different from the account that initiated execution of the task. When a user accesses the second account, for example on one of the user devices 300(a)-(c), he may receive a notification that a request for further input has been received.

The duration of execution of a task, between initiation of the task and completion of the task, may last for an extended period because of pausing of the task in flight. An extended period may for example last one or more hours, days, or weeks. An advantage of the possibility to pause a task for extended period means that progress and/or results achieve during partial execution of the task may be preserved, while a response to a request for further input is determined.

The task management system 100 may pause a task in flight, which may comprise pausing execution of the task at the end device 200(a)-(d). A task management system 100 may pause a task for example while it determines a further output or while it awaits a response to a request for further input. An advantage of pausing a task in flight by the task management system 100 is that it may improve execution of the task. Pausing a task in flight may also have an advantage of preventing failure of execution of a task, by performing one or more further actions outside of the execution of the task, in order to assist execution of the task. In an example implementation, a task may require further data in order to continue executing, and the task management system 100 may pause execution of the task while it determines how to obtain and provide the further data, instead of the task continuing, leading to a failed execution of the task. Task management system 100 may notify a user device 300(a)-(c) and/or a user that a task is paused, for example by transmitting this information to user device 300(a)-(c) instructing the task, and displaying it at user interface 150(a)-(c). This could be advantageous if the user wishes to cancel the task to free up the computing resource associated with the task or to try another way to complete the task. An unexpected pause in a task may also be indicative of a fault within the system or end device 200(a)-(d) and cause the user to investigate.

When an end device 200(a)-(d) has finished executing a task, it may send a notification to the task management system 100 to indicate the end device 200(a)-(d) has finished execution of the task. The notification may comprise a task output transmitted to the task management system 100. The notification may further comprise data regarding the outcome of the task, for example information on whether the task was finished successfully, whether execution of the task failed, or was otherwise terminated before successful completion of the task. The notification may also comprise data regarding the execution of the task, for example the duration of the execution, an overview of actions performed by the end device in order to execute the task, if and/or when task execution was paused, etc. The notification may be configured in the second operating environment of the end device 200(a)-(d).

The task management system 100 may process the received notification of a finished task, and/or received data associated with this notification. Processing the information may comprise converting at least some of the received finishing notification data from the second operating environment to a first operating environment of the task management system 100. The task management system 100 may provide information to the user device 300(a)-(c) to indicate to a user that a requested task has been completed, for example in the form of the data processed to be configured in the first operating environment. For example, the user interface 150(a)-(c) may indicate that a task has been completed, it may provide the output provided by the task, and/or data determined based on processing of the task. If a task has failed to execute, the task management system 100 may provide a notification to the user device 300(a)-(c) with this information, which may further comprise information why or how the task execution failed. The user device may provide to the privileged user, via user interface 150(a)-(c) an option to re-start execution of the task, by providing an input to the task management system 100.

As part of the process of determining the task from the input, converting of the task to an output, providing the output to an end device 200(a)-(d), and/or execution of the task by the end device 200(a)-(d), the task management system 100 may perform one or more processing steps, thereby generating task execution data. The task execution data may be stored by the task management system 100, for example in the secure container 110. Task execution data may be required by the task management system in order to complete the steps leading to the task being executed. Task execution data stored on the task management system 100 may pose a security risk, as it may comprise a combination of task data and input data specific to the task. Such a combination may for example be used to determine an output of the task to provide to an end device 200(a)-(d). It may further comprise for credentials related to the task execution.

In order to keep the network 10 and end devices 200(a)-(d) secure, it is desirable to limit the availability of task execution data on the task management system 100. Therefore, the task management system may remove task execution data after when it is no longer needed by the system. For example, a task management system may determine no further actions are required in relation to a task, and remove the task execution data relating to that task in response to that determination. Removing the task execution data may further comprise removing the secure container 110 used to determine and/or convert the task to an output. Removing the secure container 110 may comprise deleting data relating to the creation and the functioning of the secure container, as well as the secure container 110 itself. The secure container 110 may be a software creation, and deleting the secure container 110 may comprise deleting the code forming the secure container 110.

In one example implementation, the task management system 100 may remove task execution data after receiving confirmation that the task has been executed. The task management system 100 may receive a notification from an end device 200(a)-(d) comprising a confirmation that a task has finished executing, for example, that the task has been executed successfully. In response, the task management system 100 may perform any further processing steps required, e.g. processing an output of the executed task, notifying the user device of the execution of the task. The task management system 100 may then remove the task execution data. Removing task execution data may comprise deleting the task execution data. Removing the task execution data may comprise transmitting a copy of the task execution data may for storage in a secure task log 140, which will be described in more detail below.

The task management system 100 may store data relating to actions, operations, and events in a task log 140. A task log 140 may be comprised within the task management system 100, as illustrated in FIG. 1. Alternatively, the task log 140 may be stored externally to the task management system 100, wherein a secure communication channel may exist between the task management system 100 and task log 140. Data may be stored in the task log 140 may relate for example to events occurring at the task management system 100, events occurring at a user device 300(a)-(c), and/or events occurring at an end device 200(a)-(d). The task log 140 may comprise a plurality of separate entries, for example, a separate task log entry maybe created for each performed task. The task log 140 may further comprise a task log entry actions, operations, and events not related to a particular task, for example relating to attempted and/or successful login events at a user device 300(a)-(c). An advantage of keeping such a log of data relating to the task management system 100 operation, is that this data may be used to analyse behaviour of the task management system 100 at a later point in time, for example to search for potential security risks. The task log 140 may store data relating to task determination and execution even after task execution data and/or a secure container 110 used to convert and execute the task have been destroyed and deleted.

The task log may be stored in a digital distributed ledger, which may also be referred to as a blockchain. This may provide an advantage of securing the data in the task log against tampering, to improve the trustworthiness of the stored data in the task log.

Data relating to an event may be stored in the task log during the event occurring. For example, a task may comprise different steps, and data relating to those different steps may be stored in the task log while the task is still being executed. Alternatively, data relating to an event may be stored upon completion of an event. For example, ask execution data may be stored temporarily by the task management system 100 outside of the task log 140, until execution of a task has finished. The task management system may then save the task execution data in the task log 140 before deleting the task execution data stored in the task management system 100.

The task management system 100 may perform security analysis on data relating to the execution of a task. Data relating to the execution of a task may comprise for example the input received via a user device 300(a)-(c), one or more tasks obtained from task repository 120, data retrieved from operating environment repository 130, the secure container 110, output from the secure container 110, communications from an end device 200(a)-(d), etc. Security analysis may comprise performing static analysis on the data. Static analysis, which may also be referred to as static code analysis or static program analysis, may comprise analysis of code and data related to code, without executing the code. Specifically, the static analysis may be performed on the code comprised within the data. Static analysis may be performed before execution of the task. The static analysis of a task may be performed before placing the task in the task repository 120, when retrieving the task from the task repository 120 to convert it into an output, or both. An advantage of performing static analysis on code relating to a task, is that the code is analysed before it is executed as part of a task. Because a task is executed based on predetermined code, static analysis is possible on the code relating to the entire task at once, before starting execution of the code/task itself.

In a first example, static analysis is performed on a task before placing it in task repository 120. The task management system 100 may perform the static analysis. The static analysis may involve scanning through the code in order to detect embedded security credentials. Security credentials may be coded into a task in order to allow the task to gain authorisation and/or access to operations and/or data for performing the task. The presence of embedded security credentials in code poses a security risk, as a data breach may provide unauthorised parties with the security credentials.

When the task management system 100 detects embedded security credentials in the code, it may notify the user/owner of the task presenting the task to the task repository, of the detected embedded security credentials and the security risk they pose. The task management system may modify the task to remove the embedded security credentials from the code. The removed security credentials may be stored by the task management system 100 in a virtual vault 170. The task management system may provide the functionality to recombine the embedded security credentials with the code for the duration of the execution of the task. The modified task may be saved in the task repository 120, so that in case the task code is obtained by an unauthorised party, this party is not able to discover or retrieve the security credentials as they are no longer embedded. When the task is at rest, that is, stored in the task repository 120 whilst not in use, the task does not contain the necessary information to be executed. An advantage of this removal of embedded security credentials to a virtual vault may be that the task at rest, that is to say, the code of the task stored in the task repository, cannot be run by an unauthorised system or user.

In a second example, the task management system 100 may perform static analysis on the task in the secure container 110, after it has been recombined with the security credentials (or other secure access information such as a password or key). The task management system 100 may detect attempts of security credentials to leave the realm of the task. The task management system 100 may try to detect any uses of the security credentials within the task that may not relate to the task. The task management system 100 may detect attempts of the task to request security credentials it does not need. Attempts to move security credentials outside the realm of the task, or any uses of the security credentials other than required uses, may be referred to as a suspicious use or a suspicious presence of the security credentials. The task management system 100 may have information available related to a task in order to analyse the task The information may for example comprise expected uses of the security credentials in the task. An advantage of detecting suspicious uses of security credentials in the code of the task, may be that the suspicious use can be stopped before the task is executed. This may protect the security credentials from the author/developer of the task, as suspicious unauthorised uses introduced in the code by the author may be detected and avoided.

In order to identify a suspicious use or presence of security credentials, the static analysis may scan through the code for any signs of copying, external saving, or otherwise unauthorised or suspicious uses of the code. The task management system may determine this by scanning for presence and/or use of the security credentials in the task code, determining a context of the presence (e.g. by determining how the credentials are used), and comparing the context to uses or actions that may be expected for the security credentials in the task. Based on the comparison, it may determine that a use of the security credentials is suspicious or regular, for example by allocating a risk score to the task. If the task management system 100 determines a task comprises a suspicious use of security credentials, it may notify the user of the identified risk. The task management system may determine not to execute the task, for example if the risk score for a task rises above a predetermined threshold value.

In order to execute a task, security credentials may need to be provided associated with one or more of end devices 200(a)-(d). These security credentials may be different from the credentials used for authentication of a user to the network 10, and/or the credentials for authenticating a user to a privileged account of the task management system 100, for example as provided to an authentication service 190. Security credentials needed to perform at least a portion of a task may be unknown to a user requesting execution of the task, and may instead be provided by the task management system 100, or another secure entity on the network 10. In order to securely keep and provide security credentials to one or more tasks, the task management system 100 may comprise information providing access to a virtual vault 170, wherein the virtual vault 170 may comprise one or more secure credentials. It will be appreciated that security credentials may include one or more of a password, key and user ID which is required to provide access.

As described above, security credentials may have been removed from a task during static analysis. Security credentials may also have been provided to the task management system 100 alongside, but not embedded into, a task, or separately from a task. The information needed to access the virtual vault 170 may be known to the task management system 100. The information to access of the virtual vault 170 may be unknown to the task and the secure container 110 containing the task. Instead, the task and/or secure container 110 may access the virtual vault 170 through a proxy virtual vault 170 to provide an additional separation between the user and/or network and the security credentials. The task management system 100 may function as a proxy vault 160. The task and/or secure container 110 may provide a runtime key to the vault proxy when requesting access to the vault. The runtime key may for example be an API key, a pointer, a password, or another form of secure address to the virtual vault 170.

A task added to the task management system 100, may be provided with a unique task ID by the task management system. The task ID may comprise a cyclic redundancy check (CRC). The CRC may be used to check and verify the authenticity of the task identity. The CRC may detect tampering.

When a task is initiated in the task management system 100, one or both of the task and the secure container 110 containing the task, may request security credentials to be combined with the task. A request for security credentials may be accompanied by a task ID or other identifying information for the task and/or secure container 110. In some instances, the requested security credentials may comprise security credentials removed from the task during static analysis. In some instances, a task may have been written with the task management system 100 in mind In that case, the task may indicate which security credentials should be requested. In some instances task code for a task may have been written with the assumption that a person would be running the task. The task code may have been written with the assumption that the person, which may have been a privileged user, would provide security credentials. In such a case, the secure container 110 may take on the role of the assumed user, for example by detecting that the task code expects security credentials. The secure container 110 may send a request for the security credentials to the proxy vault 160.

The task management system 100 may, after receiving a request for security credentials, verify the task identity via the task ID, provide the task and/or the secure container 110 with a runtime key to the proxy vault 160 of the task management system 100, in order to obtain security credentials for the task. Access to the virtual vault 170 may be obtained using a virtual vault key, which may act as an address to the secure information in the virtual vault 170. The task and/or secure container 110 may provide the runtime key to the proxy vault 160 of the task management system 100 alongside the task ID, to request security credentials. The task management system 100, in its role as proxy vault 160, may check and verify the security credential request. If the proxy vault 160 approves the request, it will use the information it has for providing access to the virtual vault 170. This information may comprise a virtual vault key. The virtual vault key may be an API key, or another type of security key able to securely provide access to the virtual vault 170. The virtual vault key may comprise data relating to the task, for example task ID, date and/or time of task execution request, etc. The virtual vault key may track and control how the virtual vault key is used. The task management system 100 may use the combination of the virtual vault key with data relating to the task requesting the security credentials, to analyse the context of the request. The analysis may be used to assess, by the task management system, whether the request for security credentials is suspicious.

The proxy vault 160 may enable a separation between the task and the secure container 110, and the virtual vault 170. The task and/or secure container 110 may interact with the proxy vault 160, and the proxy vault 160 may, in separate actions, interact with the virtual vault 170. The task and the secure container 110 have no key to provide them with access to the virtual vault 170 itself. An advantage of this separation may be that the proxy vault 160 can analyse the security credential requests, and refuse them if they are deemed suspicious by the task management system 100. Therefore, the separation may block the task and secure container 110 from accessing security credentials it does not require. The task management system 100 may have access to data indicating which security credentials can be provided to a task.

Access to the virtual vault 170 and related data (e.g. the virtual vault key) may be arranged and controlled between the task management system 100 and the virtual vault 170. The runtime key may be provided to a task by the task management system 100 when a task is started, for example when it is placed in the secure container. The runtime key to the proxy vault 160 may be provided to the task and/or secure container 110 as part of an initialisation request by the privileged account. The runtime key may provide access to the proxy vault 160. The runtime key may be an ephemeral key in as much as it may be temporary and valid for a limited duration of time. For example, the key may be valid for a predetermined duration of time. The key may be valid for a predetermined amount of uses, for example one use, two uses, or three uses, so that once the key has been used the predetermined amount, it cannot be used again. In one example the key may be valid for a set duration of time, and limited to one use. The key may expire either when the duration of time runs out, or when it has been used, whichever occurs earlier. The task and/or secure container 110 may provide the runtime key and task ID to a proxy vault 160. The proxy vault 160 may be used to create separation between the virtual vault 170 and the secure container. The proxy vault 160 may communicate with the virtual vault 170 to obtain secure information, such as security 160 credentials, providing the key is accepted by the virtual vault. The proxy vault 160 may provide the security credentials to the task and/or secure container 110, on behalf of the virtual vault 170.

The virtual vault 170 may be located inside the network 10, or may be located external to network 10, connected to network 10 via a secure communication channel. A virtual vault 170 may be distributed across a plurality of locations, and/or may comprise a plurality of different virtual vault services, each of which may be provided internally, or be a supplied of an external provider.

The virtual vault 170 may be populated with security credentials relating to one or more of end devices 200(a)-(d). A virtual vault 170 may be accessed, using the virtual vault key, by an end device 200(a)-(d) and/or a task management system 100, in order to provide or obtain the desired security credentials.

In some implementations, the virtual vault 170 may be accessed by the end device 200(a)-(d), in which case the task management system 100 may provide a runtime key to the proxy vault 160 to the end device 200(a)-(d). When a task requires credentials in order to be executed, the task management system 100 may transmit a runtime key to the proxy vault 160 to the end device 200(a)-(d) for executing the task. The runtime key may be transmitted as part of the output provided by the task management system 100 to the end device 200(a)-(d) for executing the task. Alternatively, the runtime key to access the proxy vault 160 may be transmitted separately from the output.

An advantage of separating tasks from security credentials needed to execute the task, is that it may improve security of the system. The security credentials needed to execute a task may provide a form of privileged access to one or more of the end devices 200(a)-(d). If the security credentials and/r the task is compromised, a malicious party does not have sufficient information to execute a task, or access privileged actions on an end device 200(a)-(d) related to a task. The obtained credentials and the tasks may be combined and stored, in the secure container 110, for the duration of the execution of the task. This combination of task and security credentials data may be comprised within the task execution data, which may be deleted after execution of the task to minimise security risk associated with connecting security credentials to a corresponding task.

In some instances, the input provided by user device 300(a)-(c) may comprise user credentials. These user credentials may be different from the security credentials to be provided to an end device 200(a)-(d). The user credentials provided in the input may be used to identify one or more users. Based on a verified identification, the task management system 100 may determine a user is authorised to obtain access to security credentials in the virtual vault 170.

A task for execution on an end device 200(a)-(d) processed by a task management system 100 may comprise multiple steps, wherein each step may comprise an interaction with at least one of the end device 200(a)-(d), the task management system 100, or a user. The task processed by the task management system 100 may be performed on a plurality of devices. In some instances, the same task, involving a single end device 200(a)-(d) is performed independently on multiple end devices 200(a)-(d). An example of such a task is to test the amount of battery power remaining on each of end devices 200(a)-(d). In some instances, a task may involve a plurality of end devices 200(a)-(d), all forming part of the execution of a single instance of the task. The plurality of devices may take part in task execution in parallel, in series, or a combination of both. An example of such a task is to check the quality of transmitted and received signals over connections between a plurality of end devices 200(a)-(d).

Different parts of a task may be performed by different users. These users may for example belong to a group. A group of users may be identified to the task management system 100 as being allowed to work on the same tasks. Different users in a group may have the same or different privileges. When a task is being executed by a first user in a group, and this user is not able to perform or continue a next portion of the task, the task may be passed on to another user to continue execution. The ask may be passed on by the previous user, or the task management system 100 may pass the task on to one or more different users.

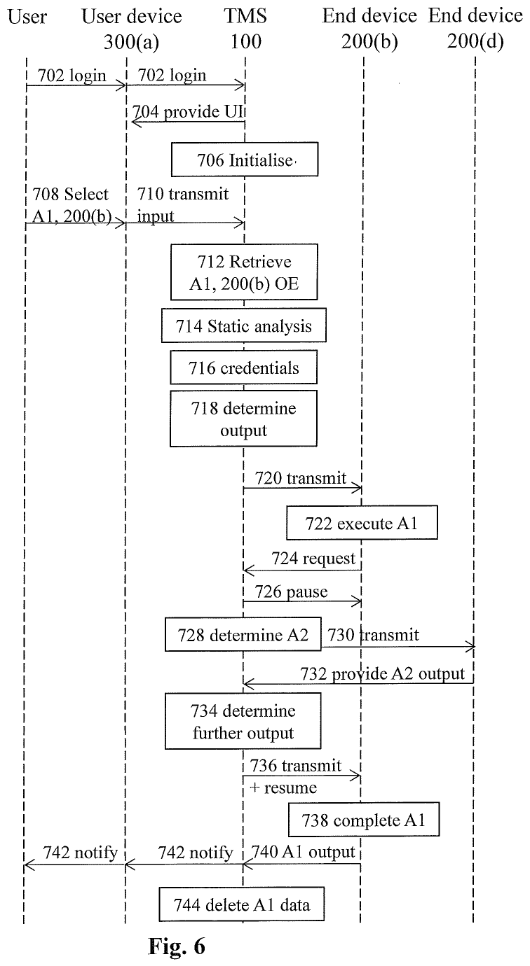

An example implementation of a task management system 100 processing a task for execution on an end device 200(b) will now be described in relation to FIG. 6. A user gains access to a privileged account of task management system 100 on user device 300(a) by providing the necessary credentials and/or going through any other necessary login procedures 702. Once the user has access the privileged account, a user interface 150(a) is provided 704 on user device 300(a) by task management system 100. The user interface 150(a) may provide a list of predetermined tasks linked to the privileged account. A successful completion of a login procedure may also start the initialisation process 706 on task management system 100, also described in relation to FIG. 4, wherein the task management system 100 receives an initialisation request. Initialisation comprises creating a secure container 110 linked to the privileged account and user device 300(a). As part of the initialisation process, the task management system 100 may determine a task ID and user metadata relating to the user requesting initialisation privileged account. The task ID and used metadata may be used to characterise and control a task execution. The task metadata and task ID may be combined in the secure container 110 with the task.

A user may then select, via user interface 150(a), one or more tasks and one or more end devices 200(a)-(d) on which to perform the one or more tasks. For example, a user may select 708 a first task A1 to be executed on end device 200(b). The user may provide any additional information required in order to execute task A1 on end device 200(b) to user device 300(a), via user interface 150(a). This additional information may comprise an input value for a variable of task A1. User device 300(a) will transmit 710 the task and end device selection and any additional provided information to the task management system 100 as input. The task management system 100 receives the input from user device 300(a), and determines the selected task A1 and end device 200(b) from the input. Once the task for execution has been determined, the task management system 100 may retrieve 712 the task A1 from task repository 120. The task management system 100 may further retrieve 712 operating environment data corresponding to a selected end device 200(b). The task management system 100 may also provide the retrieved task with a runtime key. The retrieved task and the data relating to the operating environment may comprise code. The task management system 100 may perform static analysis 714 on the retrieved code for the task and/or the operating environment. Static analysis may also be performed by the task management system 100 on the input received from user device 300(a).

Static analysis 714 may be used to identify suspicious use of security credentials in the task and/or the secure container. The task management system 100 may obtain 716 requested security credentials from the virtual vault 170, via proxy vault 160, and provide them to the task in the secure container.

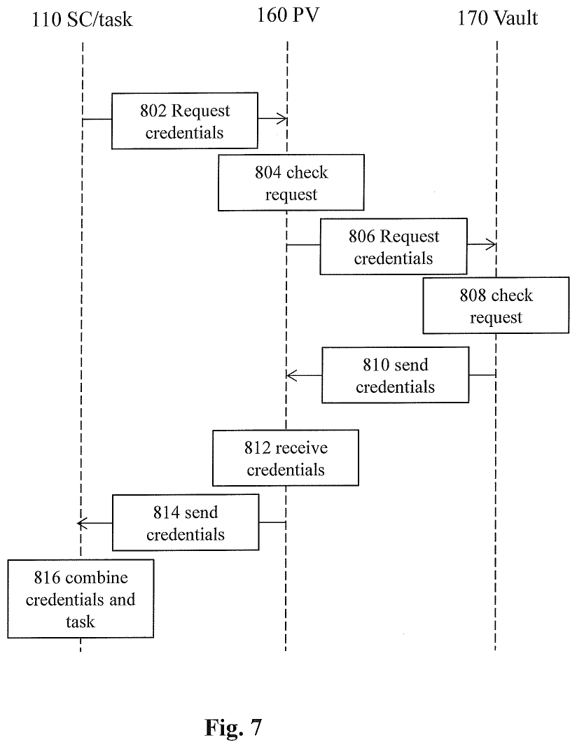

An example implementation of the request and retrieval of security credentials of step 716 will be described in relation to FIG. 7. In step 802 the secure container 110 or task initialised within the secure container 110 may send a request for one or more security credentials to a proxy vault 160 of the task management system 100, as described in more detail above. In step 804, the proxy vault 160 may receive the request, and check it for approval or refusal. If the proxy vault 160 approves the request, it may send a separate request for the security credentials to a virtual vault 170 in step 806. In step 808, the virtual vault 170 may receive the request and check it for approval or refusal. If the virtual vault 170 approves the request, it may send one or more requested security credentials to the proxy vault 160 in step 810. In step 812 proxy vault 160 may receive the security credentials from the virtual vault 170. The proxy vault 160 may then send, in step 814, the security credentials to the secure container 110 and/or task in the secure container 110. In step 816 the secure container 110 and/or task may receive the security credentials and may combine them with the task. The separation of the requests for credentials and the transmitting of the credentials is, achieved through the functioning of the proxy vault 160, may improve the security of the system, as described above. There is no direct communication between the secure container 110 and/or task and the virtual vault 170.

The task management system 100 places the task, operating environment data, and input data in the secure container 110, in which the different portions of data are combined. The combined data is then processed and converted to determine 718 an output. The combination may involve running the code relating to the retrieved task A1 in the operating environment identified for end device 200(b). The secure container 110 may be a sandbox able to manage the creation of a virtual second operating environment in which the code of task A1 is run in combination with the variable provided as part of the input. Running the code in the secure container 110 converts the task to an output suitable to be provided to end device 200(b). The task management system 100 transmits 720 the converted output to end device 200(b), which uses the provided output to execute 722 the task A1.

End device 200(b) may determine that it requires further information in order to continue execution of the task. It may transmit 724 a communication to the task management system 100 comprising a request for further information. The task management system 100 may analyse the received communication to identify that further information is required by the end device 200(b) for executing the task. In response, the task management system may pause 726 execution of the task at end device 200(b). The task management system 100 may further determine what information is needed, and based on this determination, it may determine 728 a further task A2 to be executed on a further end device 200(d). The task management system may convert the task A2 to an output as described for the first task A1 above. Converting the task A2 determined by the task management system 100 to an output may also comprise sending a request to user device 300(a) for further user input, for example an input variable for determined further task A2. The task management system 100 transmits 730 the converted output relating to task A2 to end device 200(d). End device 200(d) executed task A2 and provides 732 the A2 task output to the task management system 100. The task management system 100 processes the received task output of task A2 to determine 734 further output for transmitting 736 to end device 200(b) in response to its request. Once a response to the request for further information has been provided, the task management system 100 may instruct end device 200(b) to resume 736 execution of task A1 on end device 200(b). This instructions may be part of the further output provided to end device 200(b).

At step 736, end device 200(b) has successfully completed execution of task A1, and sends a notification 740 to task management system 100. This notification may also comprise the task output of task A1.

The task management system 100 may perform processing steps on the received task output. The task management system 100 may further transmit a notification 742 to user device 300(a) to indicate to a user 742, via user interface 150(a) that execution of task A1 has been completed successfully.

Once all actions in relation to task A1 have been completed, the task management system 100 may delete 744 all execution data temporarily stored in relation to task A1. This may involve emptying secure container 110.

Throughout the process described in relation to FIG. 6 above, data relating to the execution of task A1, and task A2, may be stored in a secure task log 140.

It will be appreciated by the person skilled in the art that various modifications may be made to the methods and apparatus described above, without departing from the scope of the invention as defined in the appended claims. Combinations of features described above may be made, also covered in the scope of the invention.

It will be appreciated that the task management system 100 may be configured to carry out any of the method steps recited above and described herein. The task management system 100 may include one or more processors configured to carry out one or more of the method steps recited above and described herein.

A computer program may be configured to provide any of the above described methods. The computer program may be provided to one or more processors, wherein executing the computer program leads the one or more processors to carry out the method configured within the computer program, as described above. The computer program may be provided on a computer readable medium. The computer program may be a computer program product. The product may comprise a non-transitory computer usable storage medium. The computer program product may have computer-readable program code embodied in the medium configured to perform the method. The computer program product may be configured to cause at least one processor to perform some or all of the method.

Accordingly, the invention may be embodied in hardware and/or in software (including firmware, resident software, micro-code, etc.) that runs on a processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated.

1. A method of processing a task for execution at an end device by a task management system, the task management system configured to provide a secure communication channel between a user device and an end device such that a user can request a task to be carried out at the end device via the task management system, the method comprising:
receiving an input configured by a first operating environment, the input relating to a task configured to be executed by an end device in a second operating environment;
determining the task from the input;
converting the task into an output which is executable on the end device; and
providing the output to the end device to execute the task.

2. The method according to claim 1, further comprising:
receiving an initialisation request from a user;
creating a secure container within the task management system in response to the initialisation request;
sending a request for further information to the user;
receiving the input within the secure container; and
converting the task into an output which is executable on the end device within the secure container.

3. The method according to claim 2, further comprising: creating a task log to store actions and events of the task management system in a task log.

4. The method according to claim 3 wherein the task log is stored in a digital distributed ledger.

5. The method according to claim 2, further comprising: destroying the secure container after execution of the task.

6. The method according to claim 1, wherein the task management system at least one of:
performs static analysis on the input before execution of the task;
determines a runtime key for a virtual vault, wherein the runtime key is provided to one or both of the task and the secure container.

7. (canceled)

8. (canceled)

9. The method according to claim 6, wherein the virtual vault is populated with security credentials relating to the task, the method further comprising accessing the virtual vault to obtain security credentials.

10. The method according to claim 9 further comprising attaching the security credentials to the output prior to providing the output to the end device.

11. The method according to claim 1, wherein receiving the input comprises receiving the task from a predetermined plurality of tasks provided on a user device.

12. The method according to claim 1, wherein converting the task to an output executable on the end device comprises:
retrieving a copy of the determined task; and
combining the task with the input to determine an output.

13. The method according to claim 1, further comprising at least one of:
storing, by the task management system, task execution data in relation to the task;
requesting further input from a user device or an end device;
temporarily pausing the execution of the task.

14. The method according to claim 1, further comprising:
receiving a confirmation that the task has been executed; and
removing the task execution data after receiving the confirmation that the task has been executed.

15. The method according to claim 1, further comprising:
receiving a communication configured in the second operating environment; and
determining a further output based on the communication configured in the second operating environment.

16. The method according to claim 15, the method further comprising, in response to the communication:
performing a further task, providing an output of the further task as further output.

17. (canceled)

18. (canceled)

19. The method according to claim 1, wherein at least one of:
the task processed by the task management system comprises multiple steps, wherein each step comprises an interaction with at least one of the end device or the task management system;
the task is performed on a plurality of end devices.

20. (canceled)

21. A method of processing a task for execution at an end device by a task management system, the task management system configured to partition a communication channel between a user device and an end device such that a user can request a task to be carried out at the end device via the task management system, the method comprising:
receiving an initialisation request from a user;
creating a secure container within a task management system in response to the initialisation request;
sending a request for further information to the user;
receiving within the secure container an input relating to a task configured to be executed by an end device;
determining the task from the input;
converting the task into an output which is executable on the end device; and
providing the output to the end device to perform the task.

22. A task management system for performing a task on an end device, the task management system configured to perform a method as claim 1 recites, the task management system comprising:
a receiver;
an execution module; and
a transmitter.

23. A network for controlling the execution of a task on an end device, the network comprising:
a user device comprising a user interface configured to control interaction between a user and the system, wherein the user device is configured to transmit an input instructing a task management system to perform a task;
a task management system configured to:
receive the input from the user device; and
transmit an output to a user device;
a device configured to:
receive an output from the task management system;
execute a task based on the received output.

24. A task engine backend server for providing data to the task management system according to the method claim 1 recites, the task engine backend server comprising:
executable code for creating a secure container environment within the task management system;
an operating environment repository configured to provide operating environments to the task management system;
a task repository configured to provide tasks to the task management system;
a location of an end device; and
a key to a virtual vault.

25. (canceled)

26. A task engine backend server for providing data to the task management system according to the method claim 21 recites, the task engine backend server comprising:
executable code for creating a secure container environment within the task management system;
an operating environment repository configured to provide operating environments to the task management system;
a task repository configured to provide tasks to the task management system;
a location of an end device; and
a key to a virtual vault.
